(19) United States
(12) Patent Application Publication
(10) Pub. No.: US 2025/0336982 A1
(43) Pub. Date: Oct. 30, 2025

(54) POSITIVE ELECTRODE FOR RECHARGEABLE LITHIUM BATTERIES AND RECHARGEABLE LITHIUM BATTERIES CONTAINING THE POSITIVE ELECTRODE

(71) Applicant: SAMSUNG SDI CO., LTD., Yongin-si (KR)

(72) Inventor: Kidong KIM, Yongin-si (KR)

(21) Appl. No.: 19/185,474

(22) Filed: Apr. 22, 2025

(30) Foreign Application Priority Data
Apr. 24, 2024 (KR) 10-2024-0054944

(51) Int. Cl. H01M 4/66; H01M 4/02; H01M 10/052

(52) U.S. Cl. CPC H01M 4/661; H01M 10/052; H01M 2004/021; H01M 2004/028

(57) ABSTRACT

A positive electrode for a rechargeable lithium battery, and rechargeable lithium battery including the positive electrode are provided. The positive electrode includes a current collector and a positive electrode active material layer on the current collector, wherein the current collector includes about 0.17 wt % to about 0.24 wt % of Cu based on 100 wt % of the current collector, and the positive electrode active material layer has a density of about 3.9 g/cc to about 4.5 g/cc.

### CROSS-REFERENCE TO RELATED APPLICATION

This application claims priority to and the benefit of Korean Patent Application No. 10-2024-0054944 filed in the Korean Intellectual Property Office on Apr. 24, 2024, the entire contents of which are incorporated herein by reference.

### BACKGROUND

### 1. Field

Positive electrodes for rechargeable lithium batteries and rechargeable lithium batteries including the positive electrodes are disclosed.

### 2. Description of the Related Art

Portable information devices such as cell phones, laptops, smart phones, and the like, or electric vehicles, use rechargeable lithium batteries having high energy density and easy portability as a driving power source. Recently, research has been conducted for using rechargeable lithium batteries with high energy density as a driving power source or power storage power source for hybrid or electric vehicles.

In order to evenly transfer electrons in a positive electrode of a rechargeable lithium battery, a positive electrode current collector is used. In order to be commercialized, a positive electrode current collector needs to have high electrochemical stability and electrical conductivity, be inexpensive, and secure increased capacity. In response to the demand for the increased capacity, there is an interest in thinning substrates, but when a positive electrode substrate is thinned, there is still a risk of cracks or pinholes occurring in the substrate.

### SUMMARY

Example embodiments provide a substrate with excellent physical properties, with the substrate being suitable for use as a positive electrode current collector for rechargeable lithium batteries.

In some example embodiments, a positive electrode for a rechargeable lithium battery includes a current collector; and a positive electrode active material layer on the current collector, wherein the current collector includes about 0.17 wt % to about 0.24 wt % of Cu based on 100 wt % of the current collector, and the positive electrode active material layer has a density of about 3.9 g/cc to about 4.5 g/cc.

In some example embodiments, a rechargeable lithium battery includes the positive electrode for the rechargeable lithium battery; a negative electrode; and an electrolyte.

In some example embodiments, a substrate having optimal physical properties for use as a positive electrode current collector of a rechargeable lithium battery is provided.

### BRIEF DESCRIPTION OF THE DRAWINGS

FIGS. 1 to 4 are cross-sectional views schematically showing a rechargeable lithium battery according to some example embodiments.

### DETAILED DESCRIPTION

Hereinafter, specific embodiments will be described in detail so that those of ordinary skill in the art can easily implement them. However, this disclosure may be embodied in many different forms and is not limited to the example embodiments set forth herein.

The terminology used herein is used to describe embodiments only and is not intended to limit the present disclosure. The singular expression includes the plural expression unless the context clearly dictates otherwise.

As used herein, “combination thereof” means a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but do not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

Average particle diameter may be measured by a method well known to those skilled in the art, for example, by a particle size analyzer, or by a transmission electron microscope image or a scanning electron microscope image. Alternatively, it is possible to obtain an average particle diameter value by measuring using a dynamic light scattering method, performing data analysis, counting the number of particles for each particle size range, and calculating from this data. Unless otherwise defined, the average particle diameter may mean the diameter (D₅₀) of particles having a cumulative volume of 50 volume % in the particle size distribution. As used herein, when a definition is not otherwise provided, the average particle diameter means a diameter (D₅₀) of particles having a cumulative volume of 50 volume % in the particle size distribution that is obtained by measuring the size (diameter or major axis length) of about 20 particles at random in a scanning electron microscope image.

Herein, “or” is not to be construed as an exclusive meaning, for example, “A or B” is construed to include A, B, A +B, and the like.

“Metal” is interpreted as a concept including ordinary metals, transition metals, and metalloids (semi-metals).

### Positive Electrode

In some example embodiments, a positive electrode for a rechargeable lithium battery includes a current collector; and a positive electrode active material layer on the current collector, wherein the current collector includes about 0.17 wt % to about 0.24 wt % of Cu based on 100 wt % of the current collector, and the positive electrode active material layer has a density of about 3.9 g/cc to about 4.5 g/cc. The positive electrode can improve battery reliability by realizing high capacity and high energy density, while increasing the strength of the current collector and reducing the occurrence of cracks and pinholes.

### Current Collector

The current collector according to some example embodiments is not particularly limited as long as it is conductive without causing chemical changes in the rechargeable lithium battery Examples of current collector materials include aluminum (Al), stainless steel (SUS), indium (In), magnesium. (Mg), titanium (Ti), iron (Fe), cobalt (Co), nickel (Ni), zinc (Zn), germanium (Ge), lithium (Li), or a combination thereof. As a specific example, the current collector may include aluminum, stainless steel, or a combination thereof. The shape of the current collector may be plate-shaped or thin-shaped.

A thickness of the current collector according to some example embodiments may be about 1 μm to about 50 μm, for example about 3 μm to about 40 μm, about 5 μm to about 30 μm, about 7 μm to about 20 μm, or about 8 μm to about 15 μm, in order to ensure current collection in the depth direction of the electrode. Additionally, a tensile strength of the current collector may be about 300 N/mm² to about 1000 N/mm², for example about 300 N/mm² to about 800 N/mm², about 300 N/mm² to about 600 N/mm², or about 350 N/mm² to about 500 N/mm². If the current collector has a thickness and tensile strength within the above ranges, a strength of the current collector may be improved so that a positive electrode with high density may be manufactured, which increases capacity of the positive electrode.

The current collector may be porous and may specifically have pores on the surface of the current collector. When pores are formed on the surface of the current collector, contact points between the positive electrode active material present in the positive electrode active material layer and the current collector, and contact points between the conductive material optionally present in the positive electrode active material layer and the current collector can be increased. Therefore, when a current collector with pores formed on the surface is used, as a surface area of the current collector increases, a path through which electrons flow increases, thereby increasing conductivity, and improving high-rate charging and discharging characteristics of a rechargeable lithium battery. In addition, when using a current collector with pores formed on the surface, a binding force is increased due to a large surface area of the current collector, so that cycle-life characteristics of the rechargeable lithium battery can also be improved. A porosity of the positive electrode may be about 60% to about 87%, for example, about 62% to about 85%. When the porosity is within such ranges, retention properties of the positive electrode mixture including the positive electrode active material, conductive material, binder, etc. on the positive electrode current collector, permeability of the electrolyte solution, and the energy density of the positive electrode can be improved. Herein, the porosity of the positive electrode refers to a ratio of pores present in the positive electrode to the positive electrode volume, and can be measured by, for example, a mercury intrusion method.

The current collector according to some example embodiments may include Cu at, for example, about 0.17 wt % to about 0.24 wt %, about 0.17 wt % to about 0.23 wt %, about 0.17 wt % to about 0.20 wt %, about 0.17 wt % to about 0.19 wt %, about 0.20 wt % to about 0.24 wt %, about 0.20 wt % to about 0.22 wt %, or about 0.21 wt % to about 0.24 wt % based on 100 wt % of the current collector. If the current collector is thinned to increase the capacity of the positive electrode included in the rechargeable lithium battery, physical performance may deteriorate and problems such as the current collector being broken or pinholes may occur. However, when Cu is included in the above ranges, the strength of the current collector can be improved even with a thin film thickness, and the incidence of cracks and pinholes can be significantly reduced. Accordingly, a positive electrode with high density and high capacity can be implemented, and the cycle-life characteristics and reliability of rechargeable lithium batteries including positive electrode can be improved.

### Positive Electrode Active Material Layer

The positive electrode according to some example embodiments may implement high energy density, and the density of the positive electrode active material layer may be, for example, about 3.9 g/cc to about 4.5 g/cc, about 3.9 g/cc to about 4.4 g/cc, about 4.0 g/cc to about 4.3 g/cc, or about 4.0 to about 4.2 g/cc. When the density of the positive electrode active material layer is within the these ranges, it is possible to obtain a positive electrode with excellent discharge capacity, with high energy density and high capacity being achieved while problems such as insufficient impregnation of an electrolyte solution and deterioration of high-rate characteristics are prevented. Also, problems such as the active material particles being crushed or the current collector being easily breakable are prevented.

A thickness of the positive electrode active material layer according to some example embodiments may be, for example, about 10 μm to about 400 μm, about 20 μm to about 350 μm, about 30 μm to about 300 μm, about 40 μm to about 250 μm, or about 50 μm to about 200 μm. A ratio of the thickness of the current collector to the thickness of the positive electrode active material layer may be, for example, about 1:1 to about 1:50, about 1:1 to about 1:40, about 1:1to about 1:30, about 1:1 to about 1:20, about 1:1 to about 1:10, about 1:1.2 to about 1:8, about 1:1.3 to about 1:7, or about 1:1.5 to about 1:5.5. When the thickness range of the positive electrode active material layer and the thickness ratio between the current collector and the positive electrode active material layer are within the above ranges, a positive electrode with high density can be manufactured, which has the advantage of increasing the capacity of the positive electrode. Cracks and pinholes often occur in current collectors. But in example embodiments the current collector according to the present disclosure, cracks, pinholes, and other problems can be avoided.

The positive electrode active material layer according to some example embodiments includes a positive electrode active material and may optionally include a binder and/or a conductive material.

The positive electrode active material according to some example embodiments may be a compound capable of intercalating and deintercalating lithium (lithiated intercalation compound). For example, one or more types of composite oxides of lithium and a metal selected from cobalt, manganese, nickel, and combinations thereof may be used.

The composite oxide may be a lithium transition metal composite oxide, and examples thereof may include lithium nickel-based oxide, lithium cobalt-based oxide, lithium manganese-based oxide, a lithium iron phosphate-based compound, cobalt-free lithium nickel-manganese-based oxide, lithium-manganese rich composite oxide, or combinations thereof.

As an example, a compound represented by any of the following chemical formulas may be used: LiₐA_{1-b}XbO_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0≤α≤2); LiₐNi_{1-b-c}Mn_{b}X_{c}O_{2-α}D_{α} (0.90≤a≤1.8, 0≤b≤0.5, 0≤c≤0.5, 0≤α≤2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001 ≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8). In these chemical formulas, A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

As an example, the positive electrode active material may be a high nickel-based positive electrode active material having a nickel content of greater than or equal to about 80 mol %, greater than or equal to about 85 mol %, greater than or equal to about 90 mol %, greater than or equal to about 91 mol %, greater than or equal to about 94 mol %, or greater than or equal to 99 mol % based on 100 mol % of a metal excluding lithium in the lithium transition metal composite oxide. The high-nickel-based positive electrode active materials can achieve high capacity and can be applied to high-capacity, high-density rechargeable lithium batteries.

The positive electrode active material may be in the form of particles. The average particle diameter (D₅₀) of the particles may be, for example, about 1 μm to about 30 μm. For example, the positive electrode active material may be large particles having an average particle diameter (D₅₀) of about 10 μm to about 25 um, small particles having an average particle diameter (D₅₀) of about 0.5 μm to about 8 μm, or a combination thereof. The positive electrode active material may include about 60 wt % to about 95 wt % of the large particles and about 5 wt % to about 40 wt % of the small particles. With such particles, a high energy density can be achieved. Herein, average particle diameter (D₅₀) means a diameter of particles having a cumulative volume of 50 volume % in the particle size distribution that is obtained by measuring the size (diameter or major axis length) of about 20 particles at random in a scanning electron microscope image of the positive electrode active materials.

The binder improves binding properties of positive electrode active material particles with one another and with a current collector. Examples of binders may include polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon. But the present disclosure is not limited to such binders.

The conductive material is included to provide electrode conductivity and any electrically conductive material may be used as a conductive material provided that the conductive material does not cause a chemical change. Examples of the conductive material may include a carbon-based material such as natural graphite, artificial graphite, carbon black, acetylene black, ketjen black, a carbon fiber, a carbon nanofiber, a carbon nanotube, and the like; a metal-based material of a metal powder or a metal fiber including copper, nickel, aluminum silver, and the like; a conductive polymer such as a polyphenylene derivative; or a mixture of such materials.

An amount of the positive electrode active material may be about 90 wt % to about 99.8 wt %, or about 95 wt % to about 99 wt %, and an amount of the binder and the conductive material may be about 0.1 wt % to about 5 wt %, or about 0.5 wt % to about 2.5 wt % based on 100 wt % of the positive electrode active material layer.

### Rechargeable Lithium Battery

According to example embodiments of the present disclosure, a rechargeable lithium battery includes the positive electrode; a negative electrode; and an electrolyte. Herein, the electrolyte may be a liquid electrolyte or a solid electrolyte. The rechargeable lithium battery may include the above-described positive electrode, a negative electrode, a separator between the positive electrode and the negative electrode, and an electrolyte solution. As another example, an all-solid-state rechargeable battery may include the above-described positive electrode, a negative electrode, and a solid electrolyte layer between the positive electrode and the negative electrode.

Hereinafter, a rechargeable lithium battery using an electrolyte solution will be described as an example.

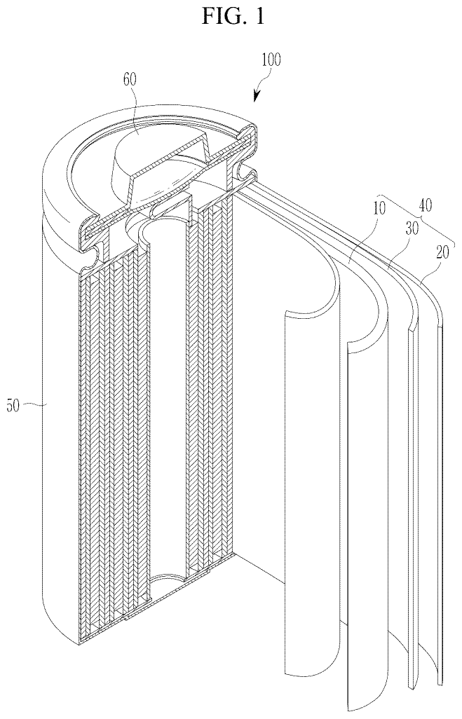

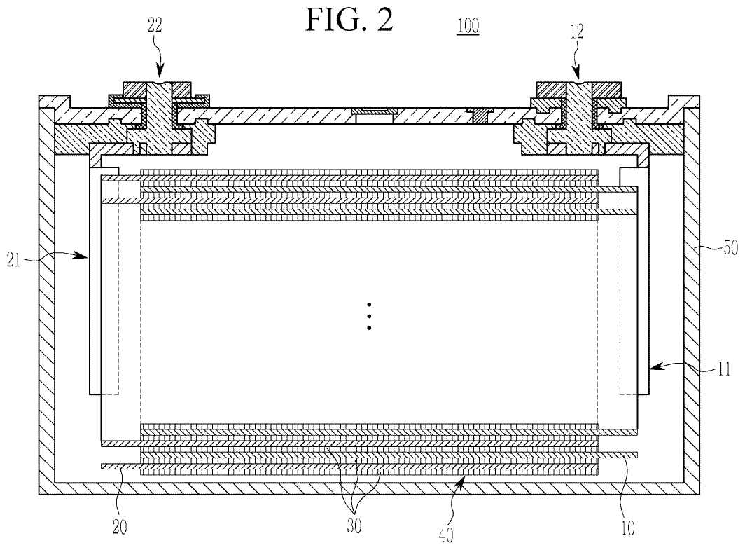

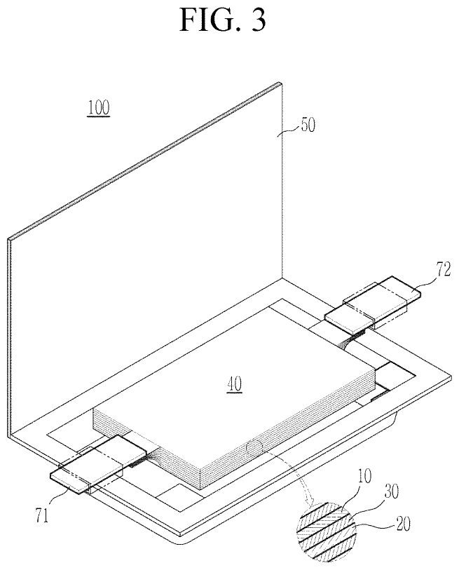

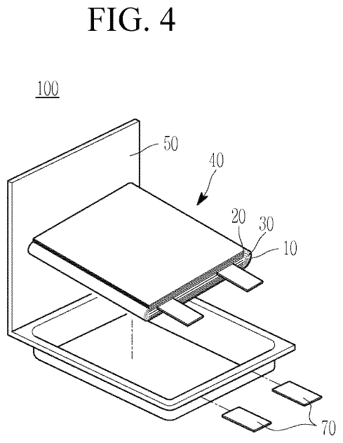

A rechargeable lithium battery may be classified as being cylindrical, prismatic, pouch, coin, etc., depending on its shape. FIGS. 1 to 4 illustrate rechargeable lithium batteries according to example embodiments, wherein FIG. 1 is a cylindrical battery, FIG. 2 is a prismatic battery, and FIGS. 3 and 4 are a pouch-shaped battery. Referring to FIGS. 1 to 4, the rechargeable lithium battery 100 includes an electrode assembly 40 with a separator 30 interposed between the positive electrode 10 and the negative electrode 20, and a case 50 in which the electrode assembly 40 is housed. The positive electrode 10, the negative electrode 20, and the separator 30 may be impregnated with an electrolyte solution (not shown). As shown in FIG. 1, the rechargeable lithium battery 100 may include a sealing member 60 that seals the case 50. As shown in FIG. 2, the rechargeable lithium battery 100 may include a positive electrode lead tab 11, a positive electrode terminal 12, a negative lead tab 21, and a negative electrode terminal 22. As shown in FIGS. 3 and 4, the rechargeable lithium battery 100 includes an electrode tab 70 having a positive electrode tab 71 and a negative electrode tab 72 to thereby function as an electrical path for current.

### Negative Electrode

The negative electrode for a rechargeable lithium battery includes negative electrode current collector and a negative electrode active material layer on the negative electrode current collector. The negative electrode active material layer includes a negative electrode active material and may further include a binder and/or a conductive material.

The negative electrode active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example, crystalline carbon, amorphous carbon, or a combination thereof as a carbon-based negative electrode active material. The crystalline carbon may be irregular, or sheet, flake, spherical, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0<x<2), a Si-Q alloy (wherein Q is an element selected from an alkali metal, an alkaline-earth metal, a Group 13 element, a Group 14 element (excluding Si), a Group 15 element, a Group 16 element, a transition metal, a rare earth element, and a combination thereof), or a combination thereof. The Sn-based negative electrode active material may be Sn, SnO₂, a Sn-based alloy, or a combination thereof.

The silicon-carbon composite may be a composite of silicon and amorphous carbon. According to example embodiments, the silicon-carbon composite may be in the form of silicon particles and amorphous carbon coated on the surface of the silicon particles. For example, the composite may include a secondary particle (core) in which silicon primary particles are assembled and an amorphous carbon coating layer (shell) on the surface of the secondary particle. The amorphous carbon may also be present between the silicon primary particles, for example, the silicon primary particles may be coated with amorphous carbon. The secondary particles may be dispersed in an amorphous carbon matrix.

The silicon-carbon composite may further include crystalline carbon. For example, the silicon-carbon composite may include a core including crystalline carbon and silicon particles, and an amorphous carbon coating layer may be provided on the surface of the core.

The Si-based negative electrode active material or Sn-based negative electrode active material may be mixed with the carbon-based negative electrode active material.

The negative electrode active material layer may include about 90 wt % to about 99 wt % of the negative electrode active material, about 0.5 wt % to about 5 wt % of the binder, and about 0 wt % to about 5 wt % of the conductive material.

The binder serves to adhere the negative electrode active material particles to each other and also to adhere the negative electrode active material to the current collector. The binder may be a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include a styrene-butadiene rubber, a (meth)acrylated styrene-butadiene rubber, a (meth)acrylonitrile-butadiene rubber, a (meth)acrylic rubber, a butyl rubber, a fluorine rubber, polyethylene oxide, polyvinylpyrrolidone, polyepichlorohydrin, polyphosphazene, poly (meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

When an aqueous binder is used as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed and used. The alkali metal may be Na, K, or Li.

The dry binder may be a polymer material capable of becoming fiber, and may be, for example, polytetrafluoroethylene, polyvinylidene fluoride, a polyvinylidene fluoride-hexafluoropropylene copolymer, polyethylene oxide, or a combination thereof.

The conductive material is included to provide electrode conductivity and any electrically conductive material may be used as a conductive material provided that it does not cause a chemical change. Examples of the conductive material include a carbon-based material such as natural graphite, artificial graphite, carbon black, acetylene black, ketjen black, a carbon fiber, a carbon nanofiber, a carbon nanotube, and the like; a metal-based material of a metal powder or a metal fiber including copper, nickel, aluminum silver, and the like; a conductive polymer such as a polyphenylene derivative; or a mixture thereof.

The negative electrode current collector may be selected from copper foil, nickel foil, stainless steel foil, titanium foil, nickel foam, copper foam, a polymer substrate coated with a conductive metal, and a combination thereof.

### Electrolyte Solution

The electrolyte solution for a rechargeable lithium battery includes a non-aqueous organic solvent and a lithium salt. The non-aqueous organic solvent serves as a medium for transmitting ions taking part in the electrochemical reaction of a battery. The non-aqueous organic solvent may be a carbonate-based, ester-based, ether-based, ketone-based, or alcohol-based solvent, an aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include methyl acetate, ethyl acetate, n-propyl acetate, dimethyl acetate, methyl propionate, ethyl propionate, decanolide, mevalonolactone, valerolactone, caprolactone, and the like. The ether-based solvent may include dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include ethanol, isopropyl alcohol, and the like and the aprotic solvent may include nitriles such as R-CN (wherein R is a C2 to C20 linear, branched, or cyclic hydrocarbon group, a double bond, an aromatic ring, or an ether group, and the like; amides such as dimethylformamide; dioxolanes such as 1,3-dioxolane, 1,4-dioxolane, and the like; sulfolanes, and the like.

The non-aqueous organic solvents can be used alone or in a combination of two or more.

When using a carbonate-based solvent, a cyclic carbonate and a chain carbonate may be mixed and used. The cyclic carbonate and the chain carbonate may be mixed in a volume ratio of about 1:1 to about 1:9.

The lithium salt dissolved in the organic solvent supplies lithium ions in a battery, enables a basic operation of a rechargeable lithium battery, and improves transportation of the lithium ions between positive and negative electrodes. Examples of the lithium salt may include at least one selected from LiSbF₆, LiBF₄, LiSbF₆, LiASF₆, LiCIO₄, LiAlO₂, LiAlCl₄, LiPO₂F₂, LiCl, LiI, LiN(SO₃C₂F₅)₂, Li(FSO₂)₂N (lithium bis (fluorosulfonyl) imide; LiFSI), LiC₄F₉SO₃, LiN(CₓF₂ₓ₊₁SO₂)(C_{y}F_{2y+1}SO₂) (wherein x and y are integers of 1 to 20), lithium trifluoromethane sulfonate, lithium tetrafluoroethane sulfonate, lithium difluorobis (oxalato) phosphate (LiDFOB), and lithium bis (oxalato) borate (LiBOB).

### Separator

Depending on the type of the rechargeable lithium battery, a separator may be present between the positive electrode and the negative electrode. The separator may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof on one or both surfaces of the porous substrate.

The porous substrate may be a polymer film formed of any one polymer selected from polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON®, and polytetrafluoroethylene, or a copolymer or mixture of two or more thereof.

The organic material may include a polyvinylidene fluoride-based polymer or a (meth)acrylic-based polymer.

The inorganic material may include inorganic particles selected from Al₂O₃, SiO₂, TiO₂, SnO₂, CeO₂, MgO, NiO, CaO, GaO, ZnO, Zr₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked.

### EXAMPLES AND COMPARATIVE EXAMPLES

Examples of the present disclosure and comparative examples are described below. However, the present disclosure is not limited to the following examples.

### Example 1

An 8 μm thick current collector including 99.72 wt % of Al and 0.18 wt % of Cu was prepared.

A positive electrode active material was prepared by mixing large particles of lithium cobalt oxide having an average particle diameter (D₅₀) of about 14 μm and small particles of lithium cobalt oxide with an average particle diameter (D₅₀) of about 4 μm in a weight ratio of 7:3. 98.5 wt % of the prepared positive electrode active material was mixed with 1.0 wt % of a polyvinylidene fluoride binder and 0.5 wt % of a carbon nanotube conductive material to prepare positive electrode active material layer slurry. The slurry was coated on a current collector and then dried and compressed, to thereby make a positive electrode. When the compressed positive electrode was analyzed using SEM, the positive electrode active material layer was found to have a thickness of about 36 μm. A sample was prepared by punching out a portion coated with the positive electrode active material layer with a puncher. The sample was weighed, a weight of the current collector with the same area was subtracted from the weight of the sample, and the result was divided by a unit volume to determine the density of the positive electrode active material layer as being 4.09 g/cc.

Subsequently, negative electrode active material layer slurry was prepared by mixing 97.5 wt % of graphite negative electrode active material, 1.5 wt % of carboxymethyl cellulose, and 1 wt % of styrene butadiene rubber in a water solvent. The negative electrode active material layer slurry was coated on a copper foil current collector and then dried and compressed to make a negative electrode.

A polytetrafluoroethylene separator and an electrolyte solution prepared by dissolving 1 M LiPF₆ in a mixed solvent of ethylene carbonate and dimethyl carbonate in a volume ratio of 3:7 were used as per a common method to make a rechargeable lithium battery cell.

### Examples 2 to 4 and Comparative Examples 1 to 3

A positive electrode and a rechargeable lithium battery cell were made substantially in the same manner as in Example 1 except that the Cu content of the current collector and the density of the positive electrode active material layer were changed as shown in Table 1.

TABLE 1

| | | Positive electrode |
|---|---|---|
| | Cu | active material |
| | (wt %) | layer density (g/cc) |
| Example 1 | 0.18 | 4.09 |
| Example 2 | 0.18 | 4.11 |
| Example 3 | 0.20 | 4.04 |
| Example 4 | 0.24 | 4.20 |
| Comparative Example 1 | 0.11 | 4.09 |
| Comparative Example 2 | 0.14 | 4.14 |
| Comparative Example 3 | 0.27 | 4.20 |

### Evaluation Example 1: Evaluation of Strength Maintenance Ability

Each of the positive electrodes according to Examples 1 to 4 and Comparative Examples 1 to 3 were evaluated with respect to ability to maintain strength by coating and drying each positive electrode active material slurry on a current collector (fabric panel) and then, comparing a length increased according to a temperature. The results of the evaluation are shown in Table 2. Specifically, after drying each of the coated positive electrode active materials at different drying temperatures, length change was measured by using a Steel scaler (Scaler, 1000 mm).

TABLE 2

| | | Elongation length (mm) | | |
|---|---|---|---|---|
| | | 100° C. | 150° C. | 200° C. |
| Example 1 | fabric panel | 10.05 | 10.08 | 10.35 |
| | coating/drying | 10.06 | 10.08 | 10.35 |
| Example 2 | fabric panel | 10.05 | 10.08 | 10.33 |
| | coating/drying | 10.06 | 10.08 | 10.33 |
| Example 3 | fabric panel | 10.05 | 10.08 | 10.30 |
| | coating/drying | 10.05 | 10.08 | 10.30 |
| Example 4 | fabric panel | 10.04 | 10.07 | 10.30 |
| | coating/drying | 10.04 | 10.07 | 10.28 |
| Comparative | fabric panel | 10.08 | 10.13 | 10.40 |
| Example 1 | coating/drying | 10.16 | 10.38 | not measurable |
| Comparative | fabric panel | 10.08 | 10.13 | 10.45 |
| Example 2 | coating/drying | 10.16 | 10.35 | not measurable |
| Comparative | fabric panel | 10.08 | 10.11 | 10.38 |
| Example 3 | coating/drying | 10.16 | 10.33 | not measurable |

Referring to Table 1, like the fabric panels, Examples 1 to 4 exhibited almost no length change after coating and drying the positive electrode materials according to a temperature change. On the other hand, as compared to the fabric panels, Comparative Examples 1 to 3 exhibited a large length change according to a temperature change after coating and drying each of the positive electrode materials. And when the temperature was increased to 200° C., the measurement of the Comparative Examples 1 to 3 was impossible.

### Evaluation Example 2: Evaluation of Cracks

The positive electrodes according to Examples 1 to 4 and Comparative Examples 1 to 3 were examined to determine whether cracks and pinholes were formed. As shown in Table 3, ◯denotes that cracks or pinholes were formed, and X denotes that cracks or pinholes were not formed. Specifically, irradiating light was directed from the opposite side of the surface coated with each of the positive electrode active materials, If the light could be seen passing through the positive electrodes, then it was determined that cracks or pinholes had been formed.

TABLE 3

| | Pinholes | Cracks |
|---|---|---|
| Example 1 | X | X |
| Example 2 | X | X |
| Example 3 | X | X |
| Example 4 | X | X |
| Comparative Example 1 | ◯ | X |
| Comparative Example 2 | ◯ | ◯ |
| Comparative Example 3 | X | ◯ |

Referring to Table 3, no pinholes or cracks were found in the positive electrodes according to Examples 1 to 4. But pinholes were formed in the positive electrode of Comparative Example 1, cracks were formed in the positive electrode of Comparative Example 3, and pinholes and cracks were formed in the positive electrode of Comparative Example 2.

While this disclosure has been described in connection with what is presently considered to be practical example embodiments, it is to be understood that the disclosure is not limited to the described embodiments. Rather, the present disclosure includes various modifications and equivalent arrangements.

### DESCRIPTION OF SYMBOLS

| | |
|---|---|
| 100: rechargeable lithium battery | 10: positive electrode |
| 11: positive electrode lead tab | 12: positive terminal |
| 20: negative electrode | 21: negative electrode lead tab |
| 22: negative terminal | 30: separator |
| 40: electrode assembly | 50: case |
| 60: sealing member | 70: electrode tab |
| 71: positive electrode tab | 72: negative electrode tab |

What is claimed is:

1. A positive electrode for a rechargeable lithium battery, the positive electrode comprising
a current collector; and
a positive electrode active material layer on the current collector,
wherein the current collector includes about 0.17 wt % to about 0.24 wt % of Cu based on 100 wt % of the current collector, and
wherein the positive electrode active material layer has a density of about 3.9 g/cc to about 4.5 g/cc.

2. The positive electrode as claimed in claim 1, wherein the positive electrode active material layer has a density of about 4.0 g/cc to about 4.2 g/cc.

3. The positive electrode as claimed in claim 1, wherein the current collector includes aluminum.

4. The positive electrode as claimed in claim 1, wherein a thickness of the current collector is about 1 μm to about 50 μm.

5. The positive electrode as claimed in claim 1, wherein a thickness of the current collector is about 8 μm to about 15 μm.

6. The positive electrode as claimed in claim 1, wherein the current collector has a tensile strength of about 300 N/mm² to about 1,000 N/mm².

7. The positive electrode as claimed in claim 1, wherein the current collector has a tensile strength of about 300 N/mm² to about 600 N/mm².

8. The positive electrode as claimed in claim 1, wherein a thickness of the positive electrode active material layer is about 10 μm to about 400 μm.

9. The positive electrode as claimed in claim 1, wherein a thickness of the positive electrode active material layer is about 50 μm to about 200 μm.

10. The positive electrode as claimed in claim 1, wherein a thickness ratio of the current collector to the positive electrode active material layer is about 1:1 to about 1:50.

11. The positive electrode as claimed in claim 1, wherein a thickness ratio of the current collector to the positive electrode active material layer is about 1:1 to about 1:10.

12. The positive electrode as claimed in claim 1, wherein the positive electrode active material layer includes a positive electrode active material that includes a lithium transition metal composite oxide.

13. The positive electrode as claimed in claim 12, wherein the positive electrode active material includes one or more of lithium nickel-based oxide, lithium cobalt-based oxide, lithium manganese-based oxide, a lithium iron phosphate-based compound, cobalt-free lithium nickel-manganese-based oxide, lithium-manganese rich composite oxide.

14. The positive electrode as claimed in claim 12, wherein the positive electrode active material includes large particles having an average particle diameter (D₅₀) of about 10 μm to about 25 μm and small particles having an average particle diameter (D₅₀) of about 0.5 μm to about 8 μm.

15. A rechargeable lithium battery, comprising:
the positive electrode for a rechargeable lithium battery as claimed in claim 1;
a negative electrode; and
an electrolyte.
